(19) United States
(12) Patent Application Publication
(10) Pub. No.: US 2011/0033703 A1
(43) Pub. Date: Feb. 10, 2011

(54) CUTTING FILAMENT WITH IMPROVED COMPOSITION FOR EDGE TRIMMERS, SCRUB CUTTERS AND THE LIKE

(76) Inventor: Emmanuel Legrand, Villeneuve (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/936,512

(22) PCT Filed: Apr. 21, 2008
(86) PCT No.: PCT/EP08/54421

§ 371 Date: Oct. 5, 2010

(51) Int. Cl. A01D 34/416; C08L 47/00; C08L 33/04; C08L 77/00

(52) U.S. Cl. 428/394; 525/420; 525/184; 525/183; 525/178; 525/181

(57) ABSTRACT

The present invention relates to a cutting member, especially to a cutting filament, for a plant-cutting device such as a scrub cutter or edge trimmer characterized in that at least one portion of the cutting member is a mixture of at least a polyamide and at least one another thermoplastic material. Another object of the invention relates to a composition for use in the manufacture of a cutting member by extrusion/drawing or by injection, characterized it is made from a mixture of at least a polyamide and at least one another thermoplastic material.

The present invention generally relates to devices for cutting vegetation such as scrub cutters, edge trimmers and the like, and is more particularly directed to new cutting filaments for such devices

Such cutting filaments are generally fitted with a combustion engine or electric motor which rotates at a high speed which may be between about 3 000 and 12 000 rpm, a rotary cutting head which carries one or more cutting lines.

Such cutting filament is generally made by extruding/drawing polyamide, and significant developments of these filaments have been known for a few years. For example, suitable shapes for reducing noise, improving cutting efficiency, etc. . . . and the provision of strands in different materials in order to improve cutting efficiency, improve biodegradability to reduce manufacturing costs, etc. . . . had been already disclosed.

The raw materials most often used to make cutting lines are synthetic substances, and more particularly polyamide 6, copolyamide 6/66 and copolyamide 6/9 or 6/12 notably. These substances can be very slightly modified or filled to improve their basic properties. These substances are most often extruded in a form of monofilaments that can have varying diameters and cross-sections, in particular a round cross-section, but also polygonal or star-shaped profiles or cross-sections.

Cutting filaments made from two or more components are also known. They are conventionally manufactured by a co-extrusion method from two sources of different materials.

More specifically, filaments including a main body or core from polyamide and a secondary portion such as a skin totally or partially surrounding the core, from a material different from that of the core, are known. A “different material” means here a material with at least one physical or chemical property which is different from that of the material of the core.

The cutting lines currently manufactured are satisfactory, but their properties, performance or other qualities are still limited by the properties of the raw materials used to make them. In particular, raw materials are more and more expensive due to the increase of crude oil among others. Moreover, traditional cutting lines made of polyamide are virtually non-degradable by oxo-degradation, photo-degradation or in the environment after use. Even ultra-violet radiation manages to damage the exterior surface at these lines, as do moisture and oxygen contained in the air, their breakdown process is extremely slow, propagated layer by layer from the exterior of the line toward its inside. Note that photo-degradation is degradation of a photodegradable molecule caused by the absorption of photons, particularly those wavelengths found in sunlight, such as infrared radiation, visible light and ultraviolet light. However, other forms of electromagnetic radiation can cause photo-degradation. Photo-degradation includes photo-dissociation, the breakup of molecules into smaller pieces by photons. It also includes the change of a molecule's shape to make it irreversibly altered, such as the denaturing of proteins, and the addition of other atoms or molecules. Furthermore, an oxo-degradation is a multi-stage process using a chemical additive to initiate degradation over the time.

Moreover, the ends or end portions of such cutting lines made of polyamide tend to fibrillates, i.e. to break up into a number of small fibers having a much smaller cross-section and effective mass than the initial strand.

Since the energy available for cutting is greater at the tip of the filament, any reduction in the cross-sectional area, and effective mass of the filament correspondingly reduces the ability of the filament to cut the vegetation that it strikes.

There is currently no known substance that would by itself be suitable for use in a cutting line that would not fibrillate and retaining its basic qualities.

There is a need for an inexpensive cutting line having an improved efficiency by a reduction or cancellation of its tendency to fibrillate, and optionally that will degrade more quickly in the environment than known filaments.

Accordingly, the present invention provides according to a first aspect a cutting member for a plant-cutting device such as a scrub cutter or edge trimmer characterized in that at least one portion of the cutting member is a mixture of at least a polyamide and at least one another thermoplastic material.

The other thermoplastic is chosen from the following group: Acrylonitrile Butadiene Styrene (ABS), Acrynitrile Methyl Methacrylate (AMMA), Cellulose Acetate (CA), Ethylene/Propylene (E/P), Ethylene/Tetrafluoethylene (ETFE), Ethylene-Vinyl Acetate (EVAC), Ethylene-Vinyl Alcohol (EVOH), Methyl Methacrylate Butadiene Styrene (MABS), Dough Molding Compound (MC), Methyl Methacrylate Butadiene Styrene (MBS), Polyamide Imide (PAI), Polycarbonate (PC), Polyethylene (PE), Polyestercarbonate (PEC), Polyetheretherketone (PEEK), Polyetherester (PEEST), Polyetherketone (PEK), Poly Ethylene Naphtalate Polyester (PEN), Polyethersulfone (PESU), Polyethylene Terephtalate (PETP), Perfluoro Alkoxyl Alkene (PFA), Polyimide (PI), Polyketone (PK), Polymethyl Methecrylate (PMMA), Polymethyl Pentene (PMP), Polyoxymethylene (Acetal) (POM), Polyphenylene Ether (PPE), Polyphenylene Oxide (PPOX), Polyphenylene sulphide (PPS), Polysulfone (PSU), Polytetrafluoroethylene (PTFE), Polyvinyl Acetate (PVAC), Polyvinyl Chloride (PVC), Polyvinylidene Fluoride (PVDF), Polyvinyl Fluoride (PVF), Styrene/Butadiene (S/B), Styrene Maleic Anhydride (SMAH, SM/A, SMA).

Said other thermoplastic material is a linear polyethylene (PE).

Preferentially, said other thermoplastic material is a highly branched or hyper-branched thermoplastic material.

Alternatively, the other thermoplastic material is a low-density polyethylene (PELD).

The cutting member contains from 5 to 50% of said other thermoplastic material.

Moreover, the cutting member according to the invention further contains at least one compatibilization agent.

Said compatibilization agent is Ethylene Vinyl Acetate (EVA).

The cutting member comprises a first core-forming portion and a second portion at least partially surrounding the core portion and defining at least one area for attacking plants.

Said second portion can entirely surrounds the core of the cutting member.

Both cutting member portions are made from mixtures of at least a polyamide and at least one another thermoplastic material, said second portion being made from a mixture containing a larger proportion of said other thermoplastic material than the first portion. Advantageously, said other thermoplastic material is a recycled material.

The present invention further provides a composition for use in the manufacture of a cutting member such as a cutting filament by extrusion/drawing or injection, characterized it is made from a mixture of at least a polyamide and at least one another thermoplastic material.

The other thermoplastic is chosen from the following group: Acrylonitrile Butadiene Styrene (ABS), Acrynitrile Methyl Methacrylate (AMMA), Cellulose Acetate (CA), Ethylene/Propylene (E/P), Ethylene/Tetrafluoethylene (ETFE), Ethylene-Vinyl Acetate (EVAC), Ethylene-Vinyl Alcohol (EVOH), Methyl Methacrylate Butadiene Styrene (MABS), Dough Molding Compound (MC), Methyl Methacrylate Butadiene Styrene (MBS), Polyamide Imide (PAI), Polycarbonate (PC), Polyethylene (PE), Polyestercarbonate (PEC), Polyetheretherketone (PEEK), Polyetherester (PEEST), Polyetherketone (PEK), Poly Ethylene Naphtalate Polyester (PEN), Polyethersulfone (PESU), Polyethylene Terephtalate (PETP), Perfluoro Alkoxyl Alkene (PFA), Polyimide (PI), Polyketone (PK), Polymethyl Methecrylate (PMMA), Polymethyl Pentene (PMP), Polyoxymethylene (Acetal) (POM), Polyphenylene Ether (PPE), Polyphenylene Oxide (PPOX), Polyphenylene sulphide (PPS), Polysulfone (PSU), Polytetrafluoroethylene (PTFE), Polyvinyl Acetate (PVAC), Polyvinyl Chloride (PVC), Polyvinylidene Fluoride (PVDF), Polyvinyl Fluoride (PVF), Styrene/Butadiene (S/B), Styrene Maleic Anhydride (SMAH, SM/A, SMA).

Said other thermoplastic material is a linear polyethylene (PE).

Preferentially, said other thermoplastic material is a highly branched or hyper-branched thermoplastic material.

Alternatively, the other thermoplastic material is a low-density polyethylene (PELD).

The composition according to the invention contains from 5 to 50% of said other thermoplastic material.

Moreover, said composition further contains at least one compatibilization agent.

Said compatibilization agent is Ethylene Vinyl Acetate (EVA).

Advantageously, said other thermoplastic material is a recycled material.

Embodiments of varying scope are described herein. In addition to the aspects described in this summary, further aspects will become apparent by reference to the drawings and with reference to the detailed description that follows.

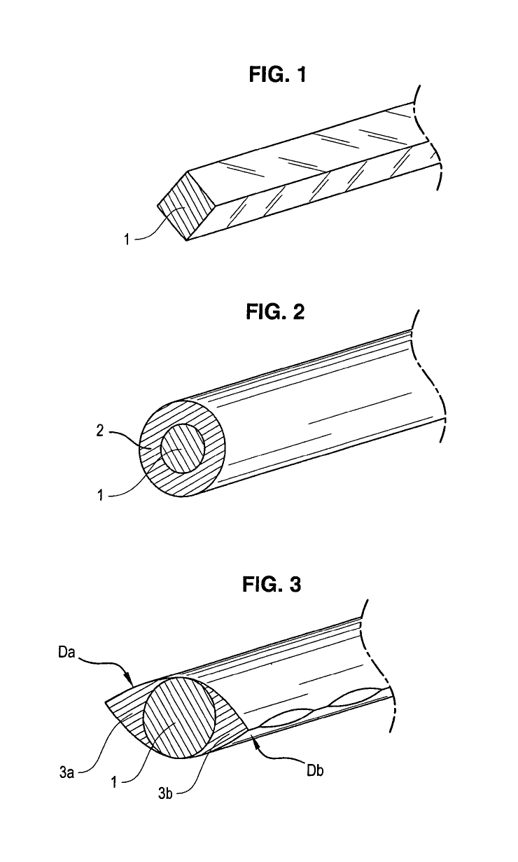

FIG. 1 is a schematic sectional perspective view of a cutting filaments with a first construction according to the invention,

FIG. 2 is a schematic sectional perspective view of a cutting filaments with a second construction according to the invention,

FIG. 3 is a schematic sectional perspective view of a cutting filaments with a third construction according to the invention,

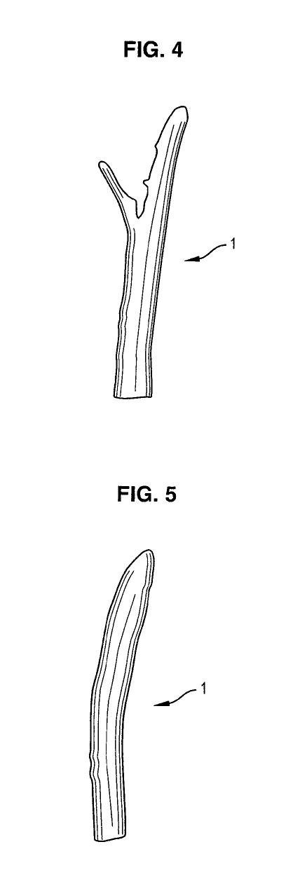

FIGS. 4 and 5 are perspective views of a used cutting filament having the construction shown in FIG. 1, made from polyamide and from a mixture according to the invention, respectively.

With reference to FIG. 1, a cutting filament has been illustrated for a motorized plant-cutting device such as an edge cutter, scrub cutter, etc., which has a symmetrical rhombus cross-section 1.

In a first embodiment, the cutting filament is made with a mixture of at least a polyamide and at least one another thermoplastic material chosen from the following list:

Acrylonitrile Butadiene Styrene (ABS), Acrynitrile Methyl Methacrylate (AMMA), Cellulose Acetate (CA), Ethylene/Propylene (E/P), Ethylene/Tetrafluoethylene (ETFE), Ethylene-Vinyl Acetate (EVAC), Ethylene-Vinyl Alcohol (EVOH), Methyl Methacrylate Butadiene Styrene (MABS), Dough Molding Compound (MC), Methyl Methacrylate Butadiene Styrene (MBS), Polyamide Imide (PAI), Polycarbonate (PC), Polyethylene (PE), Polyestercarbonate (PEC), Polyetheretherketone (PEEK), Polyetherester (PEEST), Polyetherketone (PEK), Poly Ethylene Naphtalate Polyester (PEN), Polyethersulfone (PESU), Polyethylene Terephtalate (PETP), Perfluoro Alkoxyl Alkene (PFA), Polyimide (PI), Polyketone (PK), Polymethyl Methecrylate (PMMA), Polymethyl Pentene (PMP), Polyoxymethylene (Acetal) (POM), Polyphenylene Ether (PPE), Polyphenylene Oxide (PPOX), Polyphenylene sulphide (PPS), Polysulfone (PSU), Polytetrafluoroethylene (PTFE), Polyvinyl Acetate (PVAC), Polyvinyl Chloride (PVC), Polyvinylidene Fluoride (PVDF), Polyvinyl Fluoride (PVF), Styrene/Butadiene (S/B), Styrene Maleic Anhydride (SMAH, SM/A, SMA).

The preferred proportion of the other thermoplastic is between 5 and 50% by weight. The presence of the other thermoplastic in the filament composition allows obtaining a cutting filament with appropriate flexibility and hardness, and furthering with the property of limited or no fibrillation even after extensive use.

The cutting filament composition can further contain at least one of compatibilization agent consisting preferably in Ethylene Vinyl Acetate (EVA) or in any polyolefin grafted with maleic anhydride or similar.

For instance, the compatibilizer is a material known per se for compatibilizing polyamides and polyethylenes. Examples which may be mentioned are:
polyethylene, ethylene-propylene copolymers and ethylene-butene copolymers, where all of these materials are grafted with maleic anhydride or with glycidyl methacrylate,
ethylene/alkyl (meth)acrylate/maleic anhydride copolymers, where the maleic anhydride is grafted or copolymerized,
ethylene/vinyl acetate/maleic anhydride copolymers, where the maleic anhydride is grafted or copolymerized,
the two abovementioned copolymers condensed with polyamides or oligomers of polyamides having only one amine end group,
the two abovementioned copolymers (ethylene/alkyl (meth)acrylate or ethylene/vinyl acetate) in which the maleic anhydride is replaced by glycidyl methacrylate,
ethylene/(meth)acrylic acid copolymers and optionally salts of these,
polyethylene, polypropylene or ethylene-propylene copolymers, where these polymers are grafted with a material containing a site reactive to amines; where these graft copolymers are then condensed with polyamides or polyamide oligomers having only one amine end group.

All these materials are described in the European patent application EP 0342066 and in the U.S. Pat. No. 5,342,886, the content of which is incorporated by reference in the present application.

Other compatibilization agents such as those described in the U.S. Pat. No. 3,963,799, the international patent application WO96/30447 or in the European patent application EP 1 057 870 can be used without departing of the scope of the invention.

In a particular preferred embodiment of the present invention, the cutting filament is made from a mixture of a polyamide and low-density polyethylene (LDPE).

The preferred proportion of LDPE is between 5 and 50% by weight.

In another preferred form of the invention, the other thermoplastic material is a highly branched polymer material, so-called “hyper-branched thermoplastic”. “Hyper branched” in the context of the present invention means that the degree of branching (DB) is from 10 to 99.9%, and preferably from 20 to 99%, particularly preferably from 20 to 95%. See also P. J. FLORY, J. AM. CHEM. SOC., 1952, 74, 2718, and H. FREY et al., CHEM. EUR. J., 2000, 6, n° 14, 2499 for the definition of hyper branched polymers.

According to another embodiment, the composition of the cutting filament is a mixture of polyamide and a linear Polyethylene, i.e. a high-density polyethylene (HDPE) or a linear low density polyethylene (LLDPE).

This allows obtaining a cutting filament with appropriate flexibility and hardness, and furthering with the property of limited or no fibrillation even after extensive use. The preferred proportion of HDPE is between 5 and 50% by weight.

It should be noted that the cutting filament can have any cross-sectional shape without departing from the scope of the invention.

FIG. 2 illustrates a filament construction of the invention with a central core 1 and a skin 2. In the present example, the skin 2 totally surrounds the core 1, although it could only partly surround the core.

The core has a cross-section with a simple or complex shape. In the case in point, the core 1 has a general circular section.

The skin 2 may have any desired cross-section. In the present example, the skin 2 has a circular section 2 coaxial with the core.

In this example, the core 1 is made from the same material as the whole filament disclosed in FIG. 1, i.e. with a mixture of polyamide and at least one other thermoplastic material (preferably a highly branched or hyperbranched thermoplastic chosen in the above list). The skin 2 is made on from a mixture containing a larger proportion of said other thermoplastic material than the mixture used for the core 1.

Finally, FIG. 3 illustrates another construction of a cutting filament according to the invention, with a central core 1 and two wings 3a, 3b separate from each other and further forming serrated or toothed cutting zones Da and Db.

Advantageously, the filaments according to the invention are made by a conventional extrusion/drawing process (with a co-extrusion in the case of filaments comprising two or more materials) or by injection with a composition as described above. The present further concerns the composition itself.

Moreover, the other thermoplastic material advantageously is a material obtained through recycling, e.g. from the recycling of packaging materials.

This further allows decreasing the manufacturing cost of the filament.

It should be noted here that the present invention may be combined by the skilled person with many other enhancements generally known in the field of cutting filaments (filaments with a particular shape and/or coatings or material combinations from improving the cutting efficiency, reducing the operating noise, enhancing biodegradability, preventing sticking phenomena, etc.).

This written description uses examples to disclose the invention, including the best mode, and also to enable any person skilled in the art to make and use the invention. The scope of the subject matter described herein is defined by the claims and may include other examples that occur to those skilled in the art. For instance, the other thermoplastic material can be a metallocene polyethylene, LDPE from free-radical polymerization, high-density polyethylene (HDPE), or medium-density polyethylene (MDPE), linear low-density polyethylene (LLDPE), or very-low-density polyethylene (VLDPE) which is a copolymer of ethylene and an alpha-olefin selected from among 1-butene, methylpentene, 1-hexene and 1-octene.

Moreover, the invention is intended to any cutting member for a plant-cutting device such as blades as disclosed in the U.S. Pat. No. 4,406,065 for example without departing of the scope of the invention.

Such other examples are intended to be within the scope of the claims if they have structural elements that do not differ from the literal language of the claims, or if they include equivalent structural elements with insubstantial differences from the literal language of the claims.

1- A cutting member for a plant-cutting device such as a scrub cutter or edge trimmer characterized in that at least one portion of the cutting member is a mixture of at least a polyamide and at least one another thermoplastic material.

2- A cutting member according to claim 1, characterized in that the other thermoplastic is chosen from the following group: Acrylonitrile Butadiene Styrene (ABS), Acrynitrile Methyl Methacrylate (AMMA), Cellulose Acetate (CA), Ethylene/Propylene (E/P), Ethylene/Tetrafluoethylene (ETFE), Ethylene-Vinyl Acetate (EVAC), Ethylene-Vinyl Alcohol (EVOH), Methyl Methacrylate Butadiene Styrene (MABS), Dough Molding Compound (MC), Methyl Methacrylate Butadiene Styrene (MBS), Polyamide Imide (PAI), Polycarbonate (PC), Polyethylene (PE), Polyestercarbonate (PEC), Polyetheretherketone (PEEK), Polyetherester (PEEST), Polyetherketone (PEK), Poly Ethylene Naphtalate Polyester (PEN), Polyethersulfone (PESU), Polyethylene Terephtalate (PETP), Perfluoro Alkoxyl Alkene (PFA), Polyimide (PI), Polyketone (PK), Polymethyl Methecrylate (PMMA), Polymethyl Pentene (PMP), Polyoxymethylene (Acetal) (POM), Polyphenylene Ether (PPE), Polyphenylene Oxide (PPOX), Polyphenylene sulphide (PPS), Polysulfone (PSU), Polytetrafluoroethylene (PTFE), Polyvinyl Acetate (PVAC), Polyvinyl Chloride (PVC), Polyvinylidene Fluoride (PVDF), Polyvinyl Fluoride (PVF), Styrene/Butadiene (S/B), Styrene Maleic Anhydride (SMAH, SM/A, SMA).

3- A cutting member according to claim 1, characterized in that said other thermoplastic material is a linear polyethylene (PE).

4- A cutting member according to claim 1 or 2, characterized in that said other thermoplastic material is a highly branched or hyper-branched thermoplastic material.

5- A cutting member according to claims 2 and 4, characterized in that the thermoplastic material is a low-density polyethylene (PELD).

6- A cutting member according to any one of claims 1 to 5, characterized in that the cutting member contains from 5 to 50% of said other thermoplastic material.

7- A cutting member according to any one of claims 1 to 6, characterized in that it further contains at least one compatibilization agent.

8- A cutting member according to claim 7, characterized in that said compatibilization agent is Ethylene Vinyl Acetate (EVA).

9- A cutting member according to any one of claims 1 to 8, characterized in that it comprises a first core-forming portion and a second portion at least partially surrounding the core portion and defining at least one area for attacking plants.

10- A cutting member according to claim 9, characterized in that the second portion entirely surrounds the core of the cutting member.

11- A cutting member according to claim 9 or 10, characterized in that both cutting member portions are made from mixtures of at least a polyamide and at least one another thermoplastic material, said second portion being made from a mixture containing a larger proportion of said other thermoplastic material than the first portion.

12- A cutting member according to any one of claims 1 to 11, characterized in that said other thermoplastic material is a recycled material.

13- A composition for use in the manufacture of a cutting member such as a cutting filament by extrusion/drawing or by injection, characterized it is made from a mixture of at least a polyamide and at least one another thermoplastic material.

14- A composition according to claim 13, characterized in that the other thermoplastic is chosen from the following group: Acrylonitrile Butadiene Styrene (ABS), Acrynitrile Methyl Methacrylate (AMMA), Cellulose Acetate (CA), Ethylene/Propylene (E/P), Ethylene/Tetrafluoethylene (ETFE), Ethylene-Vinyl Acetate (EVAC), Ethylene-Vinyl Alcohol (EVOH), Methyl Methacrylate Butadiene Styrene (MABS), Dough Molding Compound (MC), Methyl Methacrylate Butadiene Styrene (MBS), Polyamide Imide (PAI), Polycarbonate (PC), Polyethylene (PE), Polyestercarbonate (PEC), Polyetheretherketone (PEEK), Polyetherester (PEEST), Polyetherketone (PEK), Poly Ethylene Naphtalate Polyester (PEN), Polyethersulfone (PESU), Polyethylene Terephtalate (PETP), Perfluoro Alkoxyl Alkene (PFA), Polyimide (PI), Polyketone (PK), Polymethyl Methecrylate (PMMA), Polymethyl Pentene (PMP), Polyoxymethylene (Acetal) (POM), Polyphenylene Ether (PPE), Polyphenylene Oxide (PPOX), Polyphenylene sulphide (PPS), Polysulfone (PSU), Polytetrafluoroethylene (PTFE), Polyvinyl Acetate (PVAC), Polyvinyl Chloride (PVC), Polyvinylidene Fluoride (PVDF), Polyvinyl Fluoride (PVF), Styrene/Butadiene (S/B), Styrene Maleic Anhydride (SMAH, SM/A, SMA).

15- A composition according to claim 13, characterized in that said other thermoplastic material is a linear polyethylene (PE).

16- A composition according to claims 13 and 14, characterized in that said other thermoplastic material is a highly branched or hyper-branched thermoplastic material.

17- A composition according to claim 16, characterized in that the thermoplastic material is a low-density polyethylene (PELD).

18- A composition according to any one of claims 13 to 17, characterized in that it contains from 5 to 50% of said other thermoplastic material.

19- A composition according to any one of claims 13 to 18, characterized in that it further contains at least one compatibilization agent.

20- A composition according to claim 19, characterized in that said compatibilization agent is Ethylene Vinyl Acetate (EVA).

21- A composition according to any one of claims 12 to 20, characterized in that said other thermoplastic material is a recycled material.
